(19) United States
(12) Patent Application Publication
(10) Pub. No.: US 2019/0095796 A1
(43) Pub. Date: Mar. 28, 2019

(54) METHODS AND ARRANGEMENTS TO DETERMINE PHYSICAL RESOURCE ASSIGNMENTS

(71) Applicant: INTEL CORPORATION, SANTA CLARA, CA (US)

(72) Inventors: LI CHEN, Hillsboro, OR (US); MICHAEL LEMAY, Hillsboro, OR (US); YE ZHUANG, Portland, OR (US)

(73) Assignee: INTEL CORPORATION, SANTA CLARA, CA (US)

(21) Appl. No.: 15/713,573

(22) Filed: Sep. 22, 2017

(51) Int. Cl. G06N 3/08; G06F 9/50

(52) U.S. Cl. CPC G06N 3/084; G06F 9/5011

(57) ABSTRACT

Logic may determine a physical resource assignment via a neural network logic trained to determine an optimal policy for assignment of the physical resources in source code. Logic may generate training data to train a neural network by generating multiple instances of machine code for one or more source codes in accordance with different policies. Logic may generate different policies by adjusting, combining, mutating, and/or randomly changing a previous policy. Logic may execute and measure and/or statically determine measurements for each instance of a machine code associated with a source code to determine a reward associated with each state in the source code. Logic may apply weights and biases to the training data to approximate a value function. Logic may determine a gradient descent of the approximated value function and may backpropagate the output from the gradient descent to adjust the weights and biases to determine an optimal policy.

### TECHNICAL FIELD

Embodiments described herein are in the field of the compilers. More particularly, the embodiments relate to methods and arrangements to determine physical resource assignments such as register class assignments to variables in code and task assignments to a main processor.

### BACKGROUND

A compiler transforms a source code written in one language, such as C or C++, into a target code, or compiled code, written in another language, such as assembly code or machine code. Compilers typically transform the language in stages such as an analysis stage and a synthesis stage. The analysis stage may generate an intermediate representation of the source code to make the source code easier to synthesize. The synthesis stage may perform tasks such as code optimization to increase the speed and/or efficiency of the target code and code generation to generate the target code.

There are various high-level and low-level strategies for optimizing target code. High-level optimizations may involve machine-independent, programming operations. Low-level optimizations may involve machine-dependent transformations such as optimizations involving register allocation and task offloading.

### BRIEF DESCRIPTION OF THE DRAWINGS

FIG. 1A depicts an embodiment of a system including a multiple-processor platform, a chipset, buses, and accessories;

FIGS. 1B-D depict embodiments of variables assigned to virtual registers, a neural network to approximate a Q-learning function, and training for a neural network logic, such as the neural network logic illustrated in FIG. 1A;

FIGS. 1E-F depict embodiments for generating training data for a neural network logic and training a neural network logic, such as the neural network logic shown in FIG. 1A;

FIG. 2 depicts an embodiment of compiler logic circuitry such as the compiler logic circuitry shown in FIG. 1A;

FIGS. 3A-C depict flowcharts of embodiments to generate training data and train a neural network logic, and to determine physical resource assignments with a trained neural network; and

FIGS. 4-5 depict embodiments of a storage medium and a computing platform.

### DETAILED DESCRIPTION OF EMBODIMENTS

The following is a detailed description of embodiments depicted in the drawings. The detailed description covers all modifications, equivalents, and alternatives falling within the appended claims.

Compilers allocate physical registers to store variables, and those allocations can significantly affect the quality of the target code. If a compiler allocates two variables with overlapping lifetimes to the same register, the target code will include additional code to spill one variable to the stack and fill the register with the other variable and vice versa. Spills and fills increase execution time and code size. The additional memory operations also pressurize the load and store buffers or increase memory traffic. Thus, it is important for compilers to generate good register allocations.

Generally speaking, methods and arrangements to allocate physical resources are contemplated. Embodiments may include a novel, deep reinforcement learning system to generate a strategy for physical resource assignment for a source code. Embodiments may approximate the Q-learning function using a convolutional neural network and apply experience replay techniques to facilitate efficient algorithmic approximation convergence. Many embodiments begin with selection of an objective for the physical resource assignments such as (1) resource assignments to maximum performance and/or (2) resource assignments to minimize code size, depending on developer preferences.

Reinforcement learning (RL) is an area of machine learning concerned with how agents take actions in an environment to maximize a cumulative reward. Embodiments may implement reinforcement learning in the environment of a source code to take actions such as reassignment of register classes identified in an intermediate transformation of the source code to physical registers and/or assignment of tasks or reassignment of tasks to alternative processors to maximize an objective such as performance or minimize code size. For the objective to maximize performance, the cumulative reward may be, e.g., the total execution time reduction at the end of execution of the code and, for the objective to minimize code size, the cumulative reward may be, e.g., the total code size reduction at the end of the program. In some embodiments, the objective may balance code size reduction and execution time reduction and, in other embodiments, the objective may relate to another measurable characteristic of compiled code.

Embodiments may estimate an objective function Q(state,action), which is also referred to as the action-value function, based on a selection of an objective. The state, s, is a state of the code, an instruction of the code, or a status of execution of the code. The action, a, is a set of some or all the possible physical resource assignments for a virtual resource assignment in a source code. The objective function may include metrics or control variables that define the “goodness” of the outputs from neural network logic with respect to the objective. For instance, the metrics may include the code size, actual measured program execution time, statically-estimated program execution time, the number of fills and/or spills, and/or the like.

In some embodiments, the physical resource assignments may include physical register class assignments. For example, at an intermediate stage of compilation, compilers may assign variables to register classes based on the content of the variables. The virtual registers of any particular class are unlimited resources. However, when the compiler transforms the intermediate code into machine code, the compiler assigns the register classes to a finite set of physical registers. Compilers may default to assignment of register classes corresponding most closely to the type of program variable, which may result in heavy utilization of physical registers in a popular class and light utilization of physical registers in an unpopular class. Thus, some embodiments may improve selection of the physical registers by reassigning register classes based on the objective selected by a developer or user.

In further embodiments, the physical resource assignments may include physical processor assignments. For example, at an intermediate stage of compilation, instructions may include tasks such as execution of code. The compiler may default to assignment of tasks to a main processor. However, during execution of the code, assignment of some tasks to a main processor may increase execution time if another processor such as a graphics processor unit (GPU) is available in the system to perform the task. For instance, the main processor either performs the task when the main processor could be executing other tasks or the main processor determines that the task is assignable to the GPU and then utilizes extra clock cycles to transfer the task to the GPU. Thus, some embodiments may improve offloading of tasks to other processors.

Several embodiments perform both physical register assignments and physical processor assignments. Further embodiments perform one or more of physical register assignments, physical processor assignments, and other physical resource assignments during compilation.

Some embodiments may solve the objective function with dynamic programming. Dynamic programming, also referred to as dynamic optimization, is a method for solving a complex problem by breaking the problem down into a collection of simpler subproblems, solving each of those subproblems just once, and storing their solutions. The next time the same subproblem occurs, instead of recomputing its solution, look up the previously computed solution, advantageously saving computation time. Dynamic programming solves this by defining a sequence of value functions Q1, Q2, . . . , Qn, with an argument, s, representing the state of the system at times i from 1 to n. Dynamic programming maximizes the objective functions for the value functions, Q1, Q2, . . . , Qn, based on the initial state of the source code. The definition of Qn(s) is the value obtained in state, s, at the last time, n. The system can find the values Qi at earlier times i=n-1, n-2, . . . , 2, 1 by working backwards, using a recursive relationship. Q1 at the initial state of the system is the value of the optimal solution. Embodiments can recover the optimal values of the decision variables, one by one, by tracking back the calculations already performed. Note that, in some embodiments, “optimal” is relative to an estimation of value functions, which is based on a quality of the training data with respect to the solutions sought.

Many embodiments implement Markov Decision Processes (MDPs) to breakdown the objective function into a collection of simpler subproblems. Markov decision processes (MDPs) provide a mathematical framework for modeling decision making in situations where outcomes are partly random and partly under the control of a decision maker. A Markov Decision Process is a discrete time stochastic control process. At each time step, the process is in some state, s, and the decision maker may choose any action, a, that is available in state, s. The process responds at the next time step by randomly moving into a new state, s′, and giving the decision maker a corresponding reward.

Embodiments may implement Q-learning to solve the MDPs for the objective function. Many embodiments implement Q-learning to find an optimal action-selection policy for finite MDPs. Q-learning involves a process of training a neural network logic, such as a convolutional neural network (CNN), with compilation of multiple instances of a source code. In each of the instances of the source code, a training logic changes one or more of the actions taken, such as register class reassignments for virtual registers or physical processor assignments or reassignments. In some embodiments, for instance, the training logic may implement genetic logic to generate a sequence of register class assignments and/or task offloads.

Genetic logic may evolve the training data, which is a population of candidate solutions for an optimization problem, toward better solutions. The evolution may start from a population of randomly selected policies that are sequences of physical resource assignments or may start from a seeded population. In some embodiments, the genetic logic implements a fitness logic to select a group of better performing policies and the genetic logic randomly selects policies from the better performing policies.

The training logic may generate the training data through an iterative process that combines physical resource assignments, mutates the physical resource assignments, and/or applies the fitness logic to filter solutions based on, e.g., objective metrics or evaluation scores. The training logic may, for instance, perform benchmarking to provide evaluation scores for each instance of code executed in accordance with a policy, which may be a sequence of register class assignments or a sequence of task offloads.

Embodiments may implement Q-learning to gather information about actions, such as register class assignments and task offloads during compilation of code, metrics related to the code, and rewards related to the objective(s), such as reduction in execution time, reduction in energy consumption, or reduction in code size, to determine a value function that can provide a solution to a question regarding which action to take in a given state. The value function is a maximum value or optimal value for the objective function based on a discounted future value of assigning a physical resource at a state of execution of the code. After determining the value function, embodiments, determine an optimal physical resource to assign at a given location in the code.

The Q-learning equation is:

Q(sₜ,aₜ) Q(sₜ,aₜ)+α*(rₜ+γ*maxₐQ(sₜ₊₁,aₜ₊₁)−Q(sₜ,aₜ))

wherein the left arrow, →, implies specification of a process, where equality is due to explicitly choosing the quantity on the left, Q(sₜ,aₜ), being identical to the quantity on the right, Q(sₜ,aₜ)+α*(rₜ+γ*maxₐQ(sₜ₊₁,aₜ₊₁)−Q(sₜ,aₜ)). The Q(sₜ,aₜ) represents an objective function or action value function value at time t as a function of the state at time t and the action taken at time t. The alpha, α, represents the learning rate, which is between zero and 1. Many embodiments set the learning rate between 0.9 and 1.0 to establish an incremental step in solving for the estimation with, e.g., a gradient descent of this value function, or a weighted and biased, discrete time estimation of the value function. The rₜ represents the scalar reward for the objective function at time t, Q(sₜ,aₜ). The gamma, γ, is the discount factor, which is between zero and one, which discounts the value of future rewards based on a current action. The maxₐₜ₊₁Q(sₜ₊₁,aₜ₊₁) is the maximum value of the objective function at time t+1 as a function of the state at time t+1 and the action at time t+1. The maxₐₜ₊₁Q(sₜ₊₁,aₜ₊₁) is also the estimate of the optimal future value for taking the action at state t+1. Furthermore, the last Q(sₜ,aₜ) in the equation again represents an objective function or action value function value at time t as a function of the state at time t and the action taken at time t. Note also that the final state does not have a future value so the calculation for the final state does not include the estimate of the optimal future value.

The Q^{π}(sₜ,aₜ) for a policy denoted as pi, π, is equal to the expectation of the reward function, which is the Rₜ=rₜ+γRₜ₊₁, which is seen as the scalar reward at time t plus the discount factor multiplied by the estimate of the optimal future value in the value function above.

The basis for the Q-learning estimation is that the best or optimal action to take at time t according to the objective function of a particular policy, π, is the action that maximizes the reward function at time t+1, which is defined as Q*(sₜ,aₜ)=argmax_{π}Rₜ₊₁.

Some embodiments approximate the Q-learning with a convolutional neural network (CNN). Convolutional neural network (CNNs) use a variation of multilayer perceptrons designed to require minimal preprocessing. A CNN consists of an input and an output layer, as well as one or more hidden layers. The hidden layers may be convolutional, pooling or fully connected.

Many embodiments implement a neural network logic with a transitivity layer as the hidden layer. The transitivity layer may be a convolutional layer that applies an activation function and, in some embodiments, a pre-activation function, that presents an equation of discrete time representations of the value function with weights and biases. The weights and biases can be incrementally adjusted in steps of a size related to the learning factor, gamma, in the value function. The incremental adjustments converge the value function at an optimal action for each state after the initial state through a process of backward propagation.

Many embodiments implement experience replay by selecting mini-batches of the policies with which to perform a gradient descent and iteratively processing the mini-batches until the neural network performs gradient descent for an epoch of the training data. Backward propagation, often referred to as backpropagation, refers to a convolution of the difference between the gradient descent output for the value function at each state, which is between zero and one, and the optimal or best gradient descent which is one. In several embodiments, neural network logic convolves the difference by applying the difference to the activation function and applying a filtered version of the difference, filtered due to the application of the activation function, to the weights and biases for the value function.

With sufficient training data from instances of one or more different or diverse source codes, for a variety of policies that assign physical resources, the neural network logic may converge the value function through gradient descent and backpropagation to determine optimal policies. In many embodiments, the training logic, such as the genetic logic and the random logic, can facilitate generation of a large number of samples.

In many embodiments, after convergence of the value function for each optimal policy, the neural network logic may calculate initial states, Q(s₀,a₀) for each of the optimal policies. Thereafter, the neural network logic may select the optimal policy, based on metrics from the source code, for assigning a register class to a virtual register and/or for offloading a task from a main processor to another processor such as an accelerator, math co-processor, graphical processor unit (GPU), floating point gate array (FPGA), or other processor within a system.

Many embodiments may optimize compiled code differently for different generations and families of processors and multiple objectives. For example, passing a flag to a compiler logic circuitry may specify that optimization of a resultant binary, or machine code, is for machines or systems with a particular processor generation and for a particular objective. Similarly, training logic may generate training data for and the neural network logic may train with performance measurements from various processor generations and families. Thereafter, the neural network logic may determine, at the time of compilation, to select an optimal policy for register class assignments and/or for task offloading that are tailored for a selected processor generation and family.

Various embodiments may be designed to address different technical problems associated with physical resource assignments. Other technical problems may include support by conventional processors of many distinct register classes such as General-Purpose Registers (GPRs), vector registers, and opmask registers (i.e. the AVX-512 “K” registers); support by each register class of performance of a particular set of operations; support by GPRs of a wide range of operations; support by opmask registers of a limited set of arithmetic operations; difficulty in prediction of register pressure (i.e. the ratio between the number of live registers and the total available registers in that class) prior to register allocation; performance of equivalent operations varying based on the register class assignment; sizes of instructions (i.e. code size) of equivalent operations varying based on the register class assignment; determining when to offload tasks to another processor; run-time impacts on execution time for a main processor to offload tasks to another processor; and/or the like.

Different technical problems such as those discussed above may be addressed by one or more different embodiments. For instance, some embodiments that address problems associated with register class assignments may do so by one or more different technical means, such as, generating training data based on one or more objectives, generating training data based on a combination of two or more objectives, generating training data for register class assignments, generating training data for offloading tasks from a main processor to a different processor, generating data with a genetic logic function, generating training data with random logic, generating training data with evaluation scores based on the approximated value function implemented in the neural network logic, generating training data with feedback from the neural network logic, training a neural network logic based on the training data, training the neural network logic based on training data for multiple different main processor and/or offloading processor configurations, training the neural network logic based on training data from a diverse set of source codes based on binaries from several instances of the target codes that implement different or diverse policies for physical register assignments and/or task offloads, and the like.

Several embodiments comprise systems with multiple processor cores such as central servers, access points, and/or stations (STAs) such as modems, routers, switches, servers, workstations, netbooks, mobile devices (Laptop, Smart Phone, Tablet, and the like), sensors, meters, controls, instruments, monitors, home or office appliances, Internet of Things (IoT) gear (watches, glasses, headphones, and the like), and the like. Some embodiments may provide, e.g., indoor and/or outdoor “smart” grid and sensor services. In various embodiments, these devices relate to specific applications such as healthcare, home, commercial office and retail, security, and industrial automation and monitoring applications, as well as vehicle applications (automobiles, self-driving vehicles, airplanes, and the like), and the like.

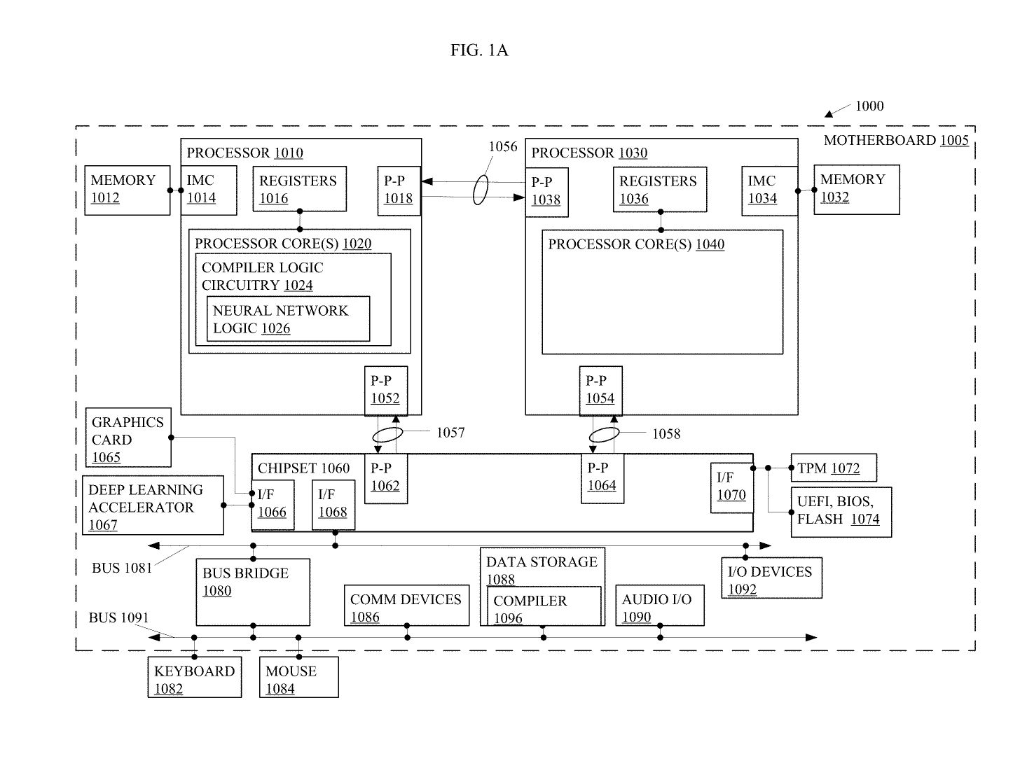

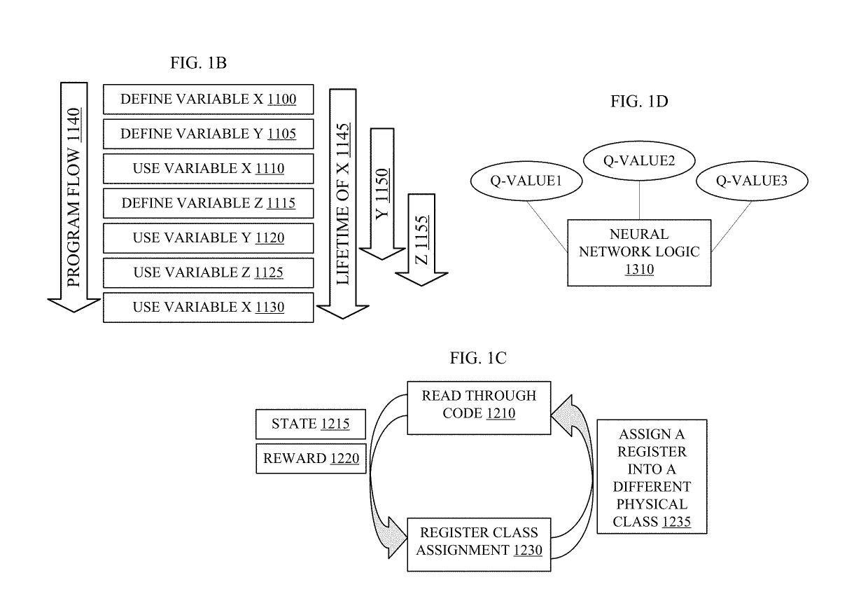

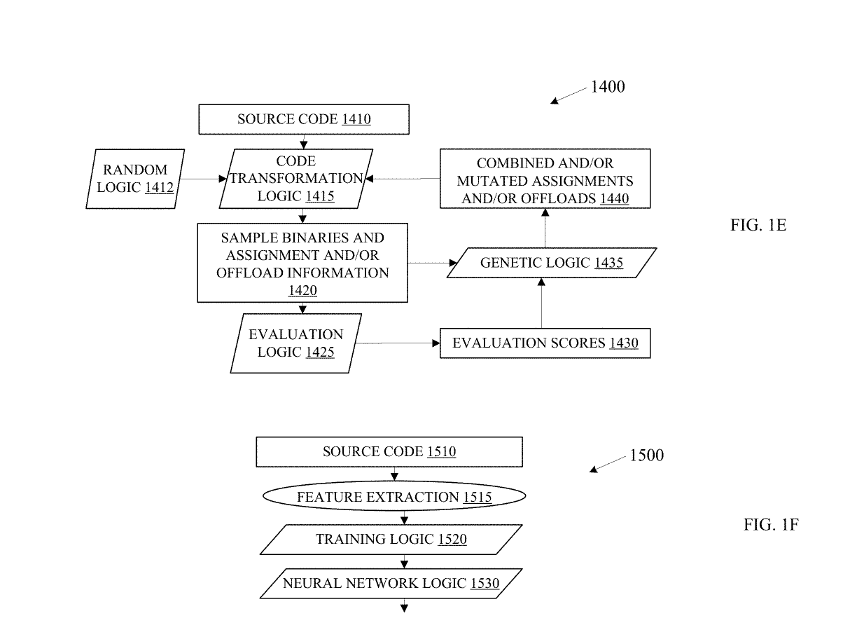

Turning now to the drawings, FIG. 1 illustrates an embodiment of a system 1000. The system 1000 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments are implemented as, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 1000 may have a single processor with one core or more than one processor. Note that the term “processor” refers to a processor with a single core or a processor package with multiple processor cores.

As shown in FIG. 1, system 1000 comprises a motherboard 1005 for mounting platform components. The motherboard 1005 is a point-to-point interconnect platform that includes a first processor 1010 and a second processor 1030 coupled via a point-to-point interconnect 1056 such as an Ultra Path Interconnect (UPI). In other embodiments, the system 1000 may be of another bus architecture, such as a multi-drop bus. Furthermore, each of processors 1010 and 1030 may be processor packages with multiple processor cores including processor core(s) 1020 and 1040, respectively. While the system 1000 is an example of a two-socket (2S) platform, other embodiments may include more than two sockets or one socket. For example, some embodiments may include a four-socket (4S) platform or an eight-socket (8S) platform. Each socket is a mount for a processor and may be associated with an socket identifier. Note that the term platform refers to the motherboard with certain components mounted such as the processors 1010 and the chipset 1060. Some platforms may include additional components and some platforms may only include sockets to mount the processors and/or the chipset.

The first processor 1010 includes an integrated memory controller (IMC) 1014 and point-to-point (P-P) interfaces 1018 and 1052. Similarly, the second processor 1030 includes an IMC 1034 and P-P interfaces 1038 and 1054. The IMC's 1014 and 1034 couple the processors 1010 and 1030, respectively, to respective memories, a memory 1012 and a memory 1032. The memories 1012 and 1032 may be portions of the main memory (e.g., a dynamic random access memory (DRAM)) for the platform such as double data rate type 3 (DDR3) or type 4 (DDR4) synchronous DRAM (SDRAM). In the present embodiment, the memories 1012 and 1032 are locally attached to the respective processors 1010 and 1030. In other embodiments, the main memory may couple with the processors via a bus and shared memory hub.

The processors 1010 and 1030 comprise caches coupled with each of the processor core(s) 1020 and 1040, respectively. In the present embodiment, the processor core(s) 1020 of the processor 1010 include a compiler logic circuitry 1024, which comprises a neural network logic 1026. The compiler logic circuitry 1024 may represent circuitry configured to implement the functionality of a compiler or may represent a combination of the circuitry within a processor and a medium to store all or part of the functionality of the compiler logic circuitry 1024 in memory such as cache, the memory 1012, buffers, registers, and/or the like. In several embodiments, the functionality of the compiler logic circuitry 1024 resides in whole or in part as code in a memory such as the compiler 1096 in the data storage 1088 attached to the processor 1010 via a chipset 1060. The functionality of the compiler logic circuitry 1024 may also reside in whole or in part in memory such as the memory 1012 and/or a cache of the processor. Furthermore, the functionality of the compiler logic circuitry 1024 may also reside in whole or in part as circuitry within the processor 1010 and may perform operations, e.g., within registers or buffers such as the registers 1016 within the processor 1010, or within an instruction pipeline of the processor 1010.

In other embodiments, more than one of the processors 1010 and 1030 may comprise functionality of the compiler logic circuitry 1024 such as the processor 1030 and/or the processor within the deep learning accelerator 1067 coupled with the chipset 1060 via an interface (I/F) 1066. The I/F 1066 may be, for example, a Peripheral Component Interconnect-enhanced (PCI-e).

The first processor 1010 couples to a chipset 1060 via P-P interconnects 1052 and 1062 and the second processor 1030 couples to a chipset 1060 via P-P interconnects 1054 and 1064. Direct Media Interfaces (DMIs) 1057 and 1058 may couple the P-P interconnects 1052 and 1062 and the P-P interconnects 1054 and 1064, respectively. The DMI may be a high-speed interconnect that facilitates, e.g., eight Giga Transfers per second (GT/s) such as DMI 3.0. In other embodiments, the processors 1010 and 1030 may interconnect via a bus.

The chipset 1060 may comprise a controller hub such as a platform controller hub (PCH). The chipset 1060 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 1060 may comprise more than one controller hub such as a chipset with a memory controller hub, a graphics controller hub, and an input/output (I/O) controller hub.

In the present embodiment, the chipset 1060 couples with a trusted platform module (TPM) 1072 and the UEFI, BIOS, Flash component 1074 via an interface (I/F) 1070. The TPM 1072 is a dedicated microcontroller designed to secure hardware by integrating cryptographic keys into devices. The UEFI, BIOS, Flash component 1074 may provide pre-boot code.

Furthermore, chipset 1060 includes an I/F 1066 to couple chipset 1060 with a high-performance graphics engine, graphics card 1065. In other embodiments, the system 1000 may include a flexible display interface (FDI) between the processors 1010 and 1030 and the chipset 1060. The FDI interconnects a graphics processor core in a processor with the chipset 1060.

Various I/O devices 1092 couple to the bus 1081, along with a bus bridge 1080 which couples the bus 1081 to a second bus 1091 and an I/F 1068 that connects the bus 1081 with the chipset 1060. In one embodiment, the second bus 1091 may be a low pin count (LPC) bus. Various devices may couple to the second bus 1091 including, for example, a keyboard 1082, a mouse 1084, communication devices 1086 and a data storage unit 1088 that may store code such as the compiler 1096. Furthermore, an audio I/O 1090 may couple to second bus 1091. Many of the I/O devices 1092, communication devices 1086, and the data storage unit 1088 may reside on the motherboard 1005 while the keyboard 1082 and the mouse 1084 may be add-on peripherals. In other embodiments, some or all the I/O devices 1092, communication devices 1086, and the data storage unit 1088 are add-on peripherals and do not reside on the motherboard 1005.

Referring now to FIGS. 1A, 1B, and 1C, FIG. 1B illustrates an example of variable assignments in a source code and FIG. 1C illustrates a process of training or generating a set of training data for the neural network logic 1026. During compilation, the compilation logic circuitry 1024 may perform an intermediate transformation of the source code that assigns each of the variables in the source code to a register class, or virtual register. The program flow 1140 illustrates a time line starting at the top of FIG. 1B with definition of a variable x 1100 and proceeds downward to illustrate the overlapping lifetimes of x 1145, y 1150, and z 1155.

The compiler logic circuitry 1024 may assign the definition of the variable x 1100 to a virtual register and the processor 1010 may have operations to perform on the variable x during the lifetime of x 1145 such as use variable x 1110 and use variable x 1130. The processor 1010 performs the operations on the variable in a physical register such as a physical register in registers 1016. Modern processors such as processors 1010 and 1030 include several different classes of physical registers such as registers 1016 and 1036, respectively. The designation of a register being a physical register distinguishes that register from a virtual register assigned to a variable during an intermediate stage of compilation. In other words, the physical register is circuitry that stores data that the processor 1010 has access to for performing operations and provides fast access to frequently accessed data to increase the performance of the processor 1010.

For illustration, in present embodiment, the compiler logic circuitry 1024 identifies the definition of variables as states 1215 in the code. The compiler logic circuitry 1024 assigns each of the variables including the definition of variable x 1100, the definition of variable y 1105, and the definition of variable z 1115 to the same register class for one instance of execution of compiled code to train the neural network logic 1026. The compiler logic circuitry 1024 will also define a policy, \pi, for the sequence of assignments and associate the policy with each state 1215 and action, \pi(sₜ,aₜ), associated with the assignments. The symbol, \pi, stands for the ith policy and the symbols, sₜ and aₜ, refer to the state 1215 and action at time t, respectively, where t=0 in the first state, t=1 in the second state, and t=2 in the third state.

Upon execution of the code, the compiler logic circuitry 1024 will determine the state 1215 of the code at each definition and measure metrics at the state of the code after execution of the action of assignment of each of the variables to the register class. If a developer defines or selects an objective for the compiler logic circuitry 1024 to maximize target code size reduction or minimize target code size, the compiler logic circuitry 1024 may measure the number of lines of code executed, the total number of lines in the code, lines in code associated with a spill and fill, and/or the like. The compiler logic circuitry 1024 may identify the instruction associated with the state 1215 and may determine a scalar representation of a reward 1220 associated with the action of assignment during the state 1215 to a register class. In some embodiments, the compiler logic circuitry 1024 determines additional data related to control variables of the objective function. In other embodiments, the reward 1220 comprises a vector that includes more than one of the metrics related to the objective function.

The first state 1215 of the code is definition of the variable x 1100, the second state 1215 in the code is the definition of the variable y 1105, and the third state 1215 in the code is the definition of the variable z 1115. The actions available to the compiler logic circuitry 1024 at each state 1215 may include assignment of the variables x, y, and z to one or more registers such as a general purpose register (GPR) that can perform a relatively broad set of operations, a vector register that can perform a more limited range of operations on multiple different numbers, or a floating point register (FPR) for floating point numbers. To maximize the objective function, the compiler may choose to use a register with a bit-width that may exceed the size of the variable but may be available. In some embodiments, training logic of the compiler logic circuitry 1024 limits the possible actions to two or three register classes in a first set of training data and selectively adds one or more additional register classes randomly, through mutations, or methodically into subsequent sets of training data. In some embodiments, the training logic of the compiler logic circuitry 1024 limits the possible actions to the typically-selected register classes in a first set of training data and selectively adds one or more atypical register class assignments randomly, through mutations, or methodically into subsequent sets of training data.

In the present embodiment, for illustration, the variables x, y, and z may be 64-bit integers numbers and the compiler logic circuitry 1024 assigns each variable to the same GPR in accordance with a default assignment by the compiler logic circuitry 1024. As a result of the action during the first state 1215, at the definition of the variable y 1105, the compiled code includes a spill of the variable x into a buffer or into the stack. The spill increases the code size for execution of the action in the second state 1215 to assign the variable y to the same GPR as x and increases the execution time for defining the variable y in the register and for storing the variable x in the buffer or stack.

At the use of variable x 1110, the compiled code includes extra code and extra execution time to spill the variable y into a buffer or stack and to fill the GPR with the definition of x from a buffer or stack. Then, at the third state 1215, the compiled code assigns the definition of the variable z 1115 to the GPR. As a result of the action, the compiled code includes a spill of x prior to defining z, as well as, a spill and fill for the use of variable y 1120, the use of variable z 1125, and the use of variable x 1130.

During compilation of a second instance, the training logic of the compiler logic circuitry 1024 may introduce a random assignment or an alternative assignment 1235 into the assignments 1230 of the register classes for variables x, y, and z. For example, the training logic may change 1235 the assignment in the first instance 1230 of the definition of variable y 1105 to a GPR class and assign a policy designation of \p2(s₀,a₀) to the definition of x 1100, a policy designation of \p2(si,ai) to the definition of y 1105, and a policy designation of \p2(s₂,a₂) to the definition of z 1115.

During execution of the second instance, the metrics at the first state 1215 for the definition of x 1100 may remain the same as during the execution of the first instance. The metrics for the second state 1215 for the definition of y 1105 may change since the compiled code does not include a spill related to storing the variable x in a buffer or stack. The code size and the execution time for the action of defining y in the vector register class is less than the spill for the action in the first instance. Thus, the reward 1220 for the objective of reducing the code size will increase. Furthermore, the total execution time and the total code size may decrease.

During compilation of a third instance, the training logic of the compiler logic circuitry 1024 may introduce a random assignment or an alternative assignment 1235 into the assignment 1230 of the register classes for variables x, y, and z based on the policy, /p2, associated with the second instance. In some embodiments, for instance, a fitness logic or code selection logic of the training logic identifies that the total execution time for the second instance is shorter than the total execution time for the first instance and generates the third variation of the sequence of register class assignments based on the policy, \p2. As a result, the compiler logic circuitry 1024 may change 1235 the assignment 1230 of variable z to a vector register and denote the policy as \p3(s₂,a₂) for the definition of z 1115.

During execution of the third instance, the metrics at the first state 1215 for the definition of x 1100 may remain the same as during the execution of the first instance. The metrics for the second state 1215 for the definition of y 1105 may remain the same as the second instance and the metrics for the third state 1215 for the definition of z 1115 may change since the compiled code does not include a spill related to moving the variable x into a buffer or stack or the variable y into a buffer or stack. The code size and the execution time for the action of defining z in the vector register is less because more vector registers are available and thus, the reward 1220 for the third state 1215 action of assigning variable z to the vector register increases by a measurable amount. Furthermore, the total execution time and the total code size may decrease and the training logic may determine that the total execution time, total code size, total number of spills and fills, and/or the like is less than the second instance. Note that while the vector register may require additional clock cycles for the processor 1024 to perform a 64-bit integer operation, the difference in execution time for the 64-bit integer operation between the vector register and the GPR may be significantly less than the additional clock cycles to execute, e.g., a spill and fill to a buffer or the memory 1012.

Since the available instructions on a processor may require that some or all their operands be from the same register file, reassigning the register class for a particular virtual register may necessitate changing the register class for other virtual registers that are used as operands by the instructions that use the first virtual register as an operand. This may transitively necessitate additional register class changes. Alternatively, it may be possible to insert a new instruction to copy a value between register files to limit the extent of transitively-required register class changes.

To illustrate, consider the following example code:
%0:gpr64=5%
%1:gpr64=72%
%2:gpr64=8%
%3:gpr64=add(%0, %1)
%4:gpr64=sub(%3, %2)

The “%0-%4” are different registers, the “=” describes the process of setting a value in the register, and gpr64 is a 64-bit GPR class. Assume for this embodiment, that there is no add instruction that operates on both the gpr64 and the xmm128 operand types and the compiler logic circuitry 1024 converts %1 to type xmm128, which is a 128-bit vector register class. As a result, the compiler logic circuitry 1024 may also convert %0 and %3 to the xmm128 type. That may transitively necessitate converting %2 and %4 to the xmm128 type.

However, if the compiler logic circuitry 1024 does not convert %2 and %4 to xmm128 for some reason, the compiler logic circuitry 1024 can, alternatively, introduce an extra instruction, %5:gpr64=COPY %3, to convert types from xmm128 to gpr64 between the two arithmetic statements:
%0:xmm128=5%
%1:xmm128=72%
%2:gpr64=8%
%3:xmm128=add(%0, %1)
%5:gpr64=COPY %3
%4:gpr64=sub(%5, %2)

Referring now to FIGs. lA and 1D, FIG. 1D illustrates a process of training a neural network logic 1310 such as the neural network logic 1026 in FIG. 1A. The neural network logic 1310 may determine the value function for each policy based on a series of rewards related to discrete time events including states and actions. The neural network logic 1310 may include a hidden convolutional layer that assigns weights and biases to the discrete time events for states and actions and may convolve the layer with corrections to the weights and biases based on differences between the expected values of the overall value function and actual values based on the training data.

In the process of converging the weights and biases of the approximated value function, the neural network logic 1310 may determine multiple optimal values for the approximated value function. Each of the values may represent a different optimal policy that depends on the initial conditions, which are the first state and the first action. The neural network logic 1310 can determine the initial conditions for each optimal policy via a backwards regression from the final state to the initial state via each of the optimal policies. The three Q-values represent the alternate initial conditions associated with the alternative optimal policies of the approximated value function.

In some embodiments, the neural network logic 1310 performs compilations based on approximated value functions prior to convergence and continues to train with data collected during each compilation. In some embodiments, the neural network logic 1310 converges based on a limited set of actions and, thereafter, adds one or more additional actions (such as additional register classes) to generate one or more additional optimal policies and/or to further refine the current optimal policies.

Referring now to FIGS. 1A, 1E, and 1F, FIGS. 1E and 1F depict embodiments of process flows for a training logic 1400 and a neural network logic 1500 of the compilation logic circuitry 1024 shown in FIG. 1A. FIG. 1E starts with the transmission of a first source code 1410 to code transformation logic 1415. The code transformation logic 1415 may transform the first source code 1410 into a target code such as machine code in stages. At an intermediate stage of the transformation, the code transformation logic 1415 may include a code format with register class assignments and task offloading opportunities. The register class assignments are states for the actions of no reassignment of the register class or reassignment of the register class to a different register class and the task offloading opportunities are states for the actions of not offloading a task, reassigning a processor to which the task is offloaded, or offloading a task from a main processor in the system such as the processors 1010 and 1030 to another processor such as a processor on a card such as the graphics card 1065 or the deep learning accelerator 1067 in FIG. 1A.

The code transformation logic 1415 may identify the register class assignments as states. The code transformation logic 1415 may also identify potential task offloading opportunities to offload tasks from the main processors 1010 and 1030, as states for offloading tasks to the graphics card 1065 and to the deep learning accelerator 1067.

During compilation of a first instance, the code transformation logic 1415 may, by default, assign register classes in accordance with a default association between the type of value associated with a variable and a particular register class. For instance, a 32-bit value may be, by default, assigned to a 32-bit register class and a floating-point number may, by default, be assigned to a floating-point register class. The code transformation logic 1415 may also, by default, assign all potential offloading tasks to the main processors 1010 and 1030. Thereafter, the code transformation logic 1415 may transform an intermediate version of the first source code 1410 into machine code.

The code transformation logic 1415 may transmit the machine code, also referred to as a binary 1420, as well as information about the states and actions of the code, to an evaluation logic 1425 and to a genetic logic 1435. The information about the states and actions may include, e.g., identifiers for lines of the machine code associated with the states and the actions taken.

The evaluation logic 1425 may evaluate different instances of machine code for one or more source codes. In response to receipt of the first instance of machine code, the evaluation logic 1425 may measure or receive measurements related to the lines of code between each state, the total number of lines of code, the actual measured or statically determined execution time from state to state, as well as the actual measured or statically determined total execution time. In some embodiments, the evaluation logic 1425 also receives from the code transformation logic 1415, a number of additional lines of code generated as a result of the action taken at each state. In other embodiments, the evaluation logic 1425 uses the first instance of machine code for the first source code 1410 as a baseline for determining rewards for modifying assignments of physical resources in one or more of the states. In other embodiments, the evaluation logic 1425 sets a number of lines as a baseline such that the first instance does not include a zero for a reward for actions taken.

The genetic logic 1435 may receive the first instance, store an indication of the policy for each state, and store an association with the first source code 1410. The genetic logic 1435 may determine one or more actions for one or more of the states to diversify the training data for the first source code 1410. In some embodiments, the genetic logic 1435 changes either assignments of register classes or assignments of tasks 1420 to another processor in a single policy. In other embodiments, the genetic logic 1435 changes both assignments of the register classes and the task offloads 1420 in the same policy.

During compilation of a second instance, the code transformation logic 1415 may receive instructions from or interact with a random logic 1412 and the genetic logic 1435. The random logic 1412 may insert random changes to an assignment of a physical resource. The genetic logic 1435 may add mutations 1440 to a prior sequence of physical resource assignments or to the default sequence of physical resource assignments. For instance, a mutation may involve determination of a probability associated with mutation of each of the physical resource assignments and determination, in a random manner, to introduce a mutation in one of more of the assignments. In some embodiments, the training logic 1400 may limit the frequency of random changes to the physical resource assignments in accordance with a setting such as a periodic change of a register class assignment in a random manner or a periodic opportunity to change a physical resource assignment in a random manner. In some embodiments, the mutations may also occur at a periodic frequency such as once per generation.

In a further embodiment, a training logic of the compiler logic circuitry limits changes to the assignment of register classes to only affect a specified set of one or more of the states or a specified set of one or more register classes. For instance, based on developer input or measurement from an instance of compiled code, the training logic may determine that the most prevalent register class assignment in compiled code is to a general-purpose register (GPR) class and that these assignments could result in collisions because the default register class assignments assign more register classes to the GPR class than there are GPRs available. If the register pressure for the GPR class reaches a threshold, the training logic may focus genetic logic on changes and/or random changes to assignments to the GPR class.

The evaluation logic 1425 may evaluate the second instance and compare the second instance to the first instance. In response to receipt of the second instance of machine code, the evaluation logic 1425 may measure or receive measurements. With these measurements and the measurements of the first instance, the evaluation logic 1425 may determine evaluation scores 1430 for the first instance and the second instance and present the evaluation scores 1430 to the genetic logic 1435. In other embodiments, the evaluation logic 1425 may interact with the neural network logic 1026 to evaluate an instance against other instances based on the contemporaneous approximation of the value function. In further embodiments, the genetic logic 1435 may wait to complete a generation of instances for training data prior to combining and/or mutating assignments in instances and, instead, implement a pre-determined pattern or algorithm to make changes during the first generation of instances for each source code.

The genetic logic 1435 may receive the second instance and the evaluation scores 1430, store the evaluation scores with associations to the respective instances, store an indication of the policy for each state, and store an association with the first source code 1410. In some embodiments, with two or more instances and evaluation scores, the genetic logic 1435 may make changes to states associated by combining the assignments of two or more of the instances. For example, the genetic logic 1435 may use some of the assignments from the first instance and some of the assignments from the second instance to create a new policy with a new sequence of physical resource assignments for a third instance. The genetic logic 1435 may interact with or instruct the code transformation logic 1415 to implement a sequence of actions or changes to a sequence of actions during compilation of the third instance. In some embodiments, the number of assignments from the first instance and the second instance will be proportional or related to the difference in their evaluation scores. In several embodiments, the genetic logic 1435 changes the default or recent actions for both register class assignments and task offloads 1420.

FIG. IF illustrates an embodiment of a process flow 1500 for a compiler logic circuitry such as the compiler logic circuitry 1024 shown in FIG. 1A. FIG. IF starts with a first source code 1510. The feature extraction 1515 represents one hot encoding of the instructions that the training logic 1520 may extract and compile from the source code 1510. The training logic 1520 may extract source code for part of or the entire source code 1510. For instance, if the number of lines of code is large, the feature extraction 1515 may be a part of the code that is more likely to have an issue with overlapping register class assignments or more likely to have tasks that can benefit by offloading the tasks to another processor.

The training logic 1520 may develop or generate a set of training data that includes discrete time data sets related to execution of multiple instances of each of multiple source codes to provide a diverse set of programs to compile. The training logic 1520 may identify states within the source code for assignment of physical resources such as register classes or physical processors and may determine a range of actions available at each of the states within the source code. In many embodiments, the training logic 1520 modifies default assignments by introducing one or more different changes to the assignments and recompiling the source code to create instances associated with various policies.

Note that while genetic logic and random logic are discussed in several embodiments, other embodiments do not include the genetic logic and/or the random logic. There are many ways to change assignments. For instance, the training logic 1520 may perform methodical changes to the physical resource assignments such as repeatedly changing one or more assignments in each instance from one physical resource to a different physical resource in accordance with a predetermined pattern.

In some embodiments, a code selection logic of the training logic may identify use of a number of variables in the source code or in the machine code. The code selection logic may identify register pressure during execution of one or more compiled instances of the source code. In further embodiments, the code selection logic may include heuristic logic to estimate the register pressure by statically analyzing the code. For example, the heuristic logic may observe that a new variable has been assigned to a given register class and determine that the change likely increases the pressure in that register class in this instance of the source code 1510.

After identifying a portion of the source code that may benefit from changes to the physical resource assignments, the training logic may focus on changing resource assignments within those portions of the source code during compilation. The training logic 1520 may perform changes within the portions of the code by identifying more prevalent resource assignments such as register class assignments to a general-purpose register (GPR) and generate instances of machine code in which one or more of these assignments are changed to assign the corresponding variables to, e.g., vector registers and/or other registers.

The training logic 1520 may also identify potential task offloading opportunities by identifying tasks that another processor can perform such as the graphics card 1065, identifying portions of the code that involve more computation cycles by the main processors 1010 and 1030, and the like. Thereafter, the training logic 1520 may selectively offload these tasks in different compiled instances of the source code and execute the source code to determine rewards associated with each instance.

In the present embodiment, the training logic 1520 stores the training data for each policy in the input layer of the neural network logic 1530. The neural network logic 1530 may begin the learning process after all the training data is available in the input layer or after a preset number of policies are available in the input layer. Thereafter, the neural network logic 1530 may sample the training data via a convolutional layer that applies one or more functions to each policy in the training data and assigns an initial set of weights and biases to the discrete time events for each policy. In some embodiments, the weights comprise a random distribution such as a Gaussian distribution of values between zero and one and the biases include a constant of, e.g., one. In further embodiments, the biases may be less than one or greater than one.

The neural network logic 1530 may determine a gradient descent for the training data and update the weights and biases for all the policies based on the results. In the present embodiment, the neural network logic 1530 performs stochastic gradient descent by computing the gradient against more than one training example at each step. This technique is also called mini-batch. At each iteration, a mini-batch logic may determine a batch of training data, which refers to the number of training data, or policies, involved during the training process. For instance, after several iterations, each iteration involving different samples of the training data, one or more of the policies will converge and the neural network logic 1530 may identify the converged policies as optimal policies.

After convergence of the optimal policies, the neural network logic 1530 may determine initial conditions for each of the optimal policies by regressively calculating each prior state starting from the final state in each of the policies. Thereafter, the neural network logic 1530 may determine an optimal register class assignment for a virtual register in the source code and/or optimal tasks to offload. The neural network logic 1530 may determine an optimal policy by identifying the objective, identifying optimal policies associated with that objective, and comparing the initial conditions of any source code submitted for compilation to the initial conditions for each of the optimal policies for the particular objective. The neural network logic 1530 may select the optimal policy with the same initial conditions and assign physical resources in accordance with the actions taken in each state of the optimal policy.

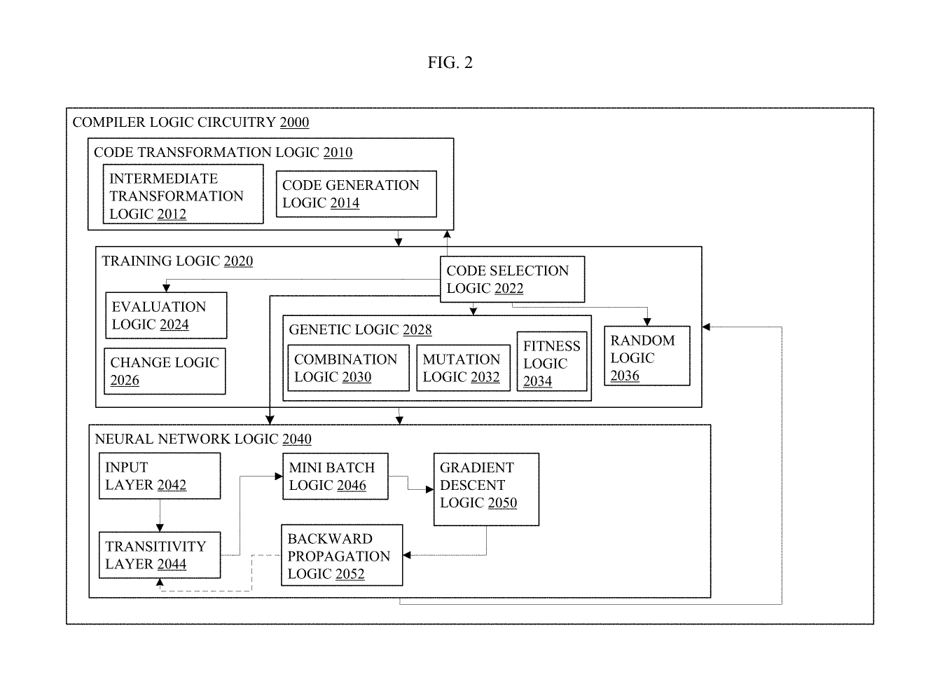

FIG. 2 depicts an embodiment of a compiler logic circuitry 2000. The compiler logic circuitry 2000 may comprise a production compiler to compile binaries for distribution, a compiler to compile binaries for users or developers, or a just-in-time compiler to compile binaries while executing the binaries. For example, the just-in-time compiler may gather training data during use and begin training a neural network logic 2040 after gathering sufficient training data.

The compiler logic circuitry 2000 may comprise circuitry; a combination of circuitry, code, and a processor to execute the code; or a combination of code and a processor to execute the code. For instance, the compiler logic circuitry 2000 may comprise a state machine and/or application-specific integrated circuit (ASIC) to perform some or all the functionality of the compiler logic circuitry 2000.

The compiler logic circuitry 2000 may selectively collect or generate policies for assigning physical resources to virtual resources identified in source code, train the neural network logic 2040 to calculate a set of the best or optimal policies for assignment of physical resources, and select the best or optimal policy for assigning resources for any source code based on the set of optimal policies. The compiler logic circuitry 2000 may comprise a code transformation logic 2010, a training logic 2020, and a neural network logic 2040.

The code transformation logic 2010 may compile source code in stages including an intermediate stage and a machine code generation stage. The code transformation logic 2010 may comprise an intermediate transformation logic 2012 and a code generation logic 2014. The intermediate transformation logic 2012 may generate an intermediate version of a source code with virtual resource assignments prior to generation of a machine code version of the source code that assigns the virtual resources to physical resources available in the particular system. The code generation logic 2014 may generate machine code based on the intermediate version of the source code and include physical resource assignments specified by the training logic 2020.

The training logic 2020 may generate training data to identify multiple policies for assigning physical resources to virtual resource assignments in the intermediate code and may transfer the policies to an input layer 2042 of the neural network logic 2040. The training logic 2020 may generate the multiple policies by determining one or more states such as instructions at which the training logic 2020 can perform one action from a set of two or more actions. For instance, an action at a state may comprise assigning physical resources to virtual resource assignments such as register classes or physical processors. The training logic 2020 may define a policy as a sequence of actions performed at each of the one or more states in the code. To generate the multiple policies, the training logic 2020 changes an action in at least one state of the one or more states to create a unique policy for the source code.

The training logic 2020 may include code selection logic 2022, evaluation logic 2024, change logic 2026, genetic logic 2028, and random logic 2036. The code selection logic 2022 may select a portion of or all the source code to generate the training data, may determine portions of code with register pressure or processing pressure at the main processor, and may receive feedback from the neural network logic 2040 to indicate an evaluation score for one or more policies. The code selection logic 2022 may also communicate a sequence of actions to perform at each of the states in a subsequent instance of machine code based on the source code.

In some embodiments, the code selection logic 2022 may coordinate adjustments to actions in a policy by selecting one or more different procedures for adjusting the actions. For instance, the training logic 2020, in the present embodiment, comprises the change logic 2026, the genetic logic 2028 and the random logic 2036 to determine actions for one or more or all the states in a new policy. The code selection logic 2022 may select one or more of the change logic 2026, the genetic logic 2028 and the random logic 2036 to determine an action for a particular state or set of states.

The evaluation logic 2024 may evaluate an instance of machine code by measuring metrics based on selection of an objective. For instance, the user or developer may select an objective of maximum performance in terms of execution time, an objective of minimum code size, or a combination of the two. For the combination, metrics or control variables for the objectives may include weights to provide more emphasis on maximum performance and less on minimum code size, or vice versa.

The evaluation logic 2024 may execute the instances of machine code to measure and/or statically estimate instances of machine code to determine total execution times and execution times between states. The evaluation logic 2024 may also measure the number of lines of code executed, the total number of lines in the code, lines in code associated with a spill and fill, lines of code between states, and the like. In some embodiments, the evaluation logic 2024 may only determine or measure metrics related to an objective selected. The evaluation logic 2024 may also determine evaluation scores or communicate with the neural network logic 2040 to determine evaluation scores based on an approximated value function to provide an indication of ranking of a policy in relation to other policies.

The change logic 2026 may determine actions related to offloading tasks from a main processor to another processor. The set of possible actions may include do not offload, offload to a first processor, offload to a second processor, and the like, depending on the number of potential processors available to perform the task offload.

The genetic logic 2028 may perform changes to actions analogous to genetic processes such as genetic combinations, genetic mutations, and fitness filtering. The genetic logic 2028 may include a combination logic 2030, a mutation logic 2032, and a fitness logic 2034. The combination logic 2030 may combine two or more policies previously evaluated by the evaluation logic 2024 to determine a new policy. The combination logic 2030 may use evaluation scores to determine proportions of the actions to use from the two or more policies.

The mutation logic 2032 may determine a mutation of one policy or a mutation of a combination of two or more policies. In some embodiments, for instance, the mutation logic 2032 may assign probabilities to each of the states in a policy and may determine a random number to determine if a state should be mutated to a different action.

The fitness logic 2034 may select policies based on evaluation scores to be candidates for modification by the genetic logic 2028 such as candidates for a combination or mutation. The random logic 2036 may randomly select and change an action such as an action to reassign a register class or to offload a task to a processor. In many embodiments, however, the random logic 2036 will select from a group of register classes that are compatible with the corresponding variable and a group of offload processors from a group of processors that are capable of performing the task.

The neural network logic 2040 may comprise a deep reinforcement learning neural network that implements dynamic programing and Q-learning to determine and solve for an approximated value function. The neural network logic 2040 may receive the training data in the form of policies at the input layer, train based on the policies to select and evaluate a set of optimal policies, and identify an optimal policy from the set of optimal policies for compiling a given source code. The neural network logic 2040 may comprise an input layer 2042, a transitivity layer 2044, a mini-batch logic 2046, a gradient descent logic 2050, and a backward propagation logic 2052.

The input layer 2042 may include the training data in the form of multiple policies comprising multiple discrete-time states associated with actions and a reward as a control variable. In some embodiments, the input layer 2042 may include additional control variables such as one or more metrics related to the objective. For instance, the additional control variables may include the total number of lines in the code or code size, actual measured program execution time for the entire code, actual measured program execution time between states, statically-estimated program execution time for the entire code, statically-estimated program execution time between states, the number of fills and/or spills, the number of lines of code executed between states, lines in code associated with a spill and fill, and the like. In several embodiments, the neural network logic 2040 may limit the additional control variables in the input layer to only those relevant to the selected objective.

The transitivity layer 2044 may be a hidden layer that includes one or more functions as well as weights and biases to convolve iterations of errors or differences determined via the gradient descent logic 2050 and backpropagated via the backward propagation logic 2052. In many embodiments, the transitivity layer 2044 associates a weight and bias with each of the discrete time states in each of the policies in the input layer 2042. The training data in the input layer 2042 may remain unchanged while the transitivity layer 2044 incrementally adjusts the weights and biases. In some embodiments, the transitivity layer 2044 includes a pre-activation function that applies an equation to the values from the input layer as well as an activation function that applies an equation to the values from the input layer 2042 and the weights and biases in the transitivity layer 2044 before passing these to the mini-batch logic 2046.

The mini-batch logic 2046 may select a smaller collection of n samples, where n is referred to as batch size, of the training data. For example, if the batch size n=100, the mini-batch logic 2046 may selectively pass 100 randomly selected training data from the policies in the input layer in each iteration, filtered through the transitivity layer 2044, to the gradient descent logic 2050. The number of iterations in each epoch is N/n, where N is the number of total training samples. The gradient descent logic 2050 may perform a gradient descent with each of the n batch of training samples, or N/n iterations of gradient descent, to estimate the gradient of the approximated value function.

The gradient descent logic 2050 may perform an incremental gradient descent that is an approximation of the gradient descent optimization method for minimizing the approximated value function in the form of a sum of differentiable functions. In other words, the gradient descent logic 2050 may find minima by iteration.

The backward propagation logic 2052 may backpropagate the correction or error output from the gradient decent through the activation function and apply the correction or error to the weights and biases in the transitivity layer 2044. In some embodiments, the backward propagation logic 2052 may backpropagate the correction or error through the transitivity layer 2044 after each iteration of the gradient descent. In other embodiments, the backward propagation logic 2052 may backpropagate the correction or error through the transitivity layer 2044 after every x number of iterations of gradient descent.

Once the values converge for the approximated value function, the neural network 2040 may identify the optimal approximated value functions, which are associated with policies, and, thus can identify the optimal policies. The neural network logic 2040 may calculate the initial states for each of the optional policies and, thereafter, determine an optimal policy for physical resource assignment by comparing the initial state of any source code against the initial states of the optimal policies.

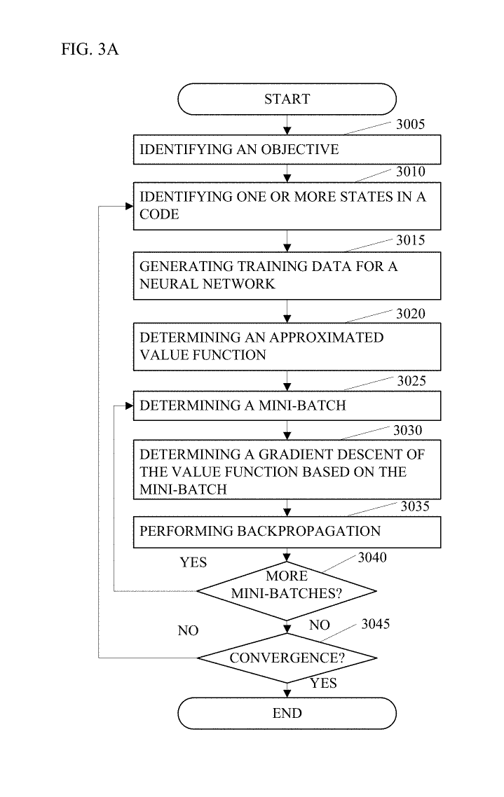

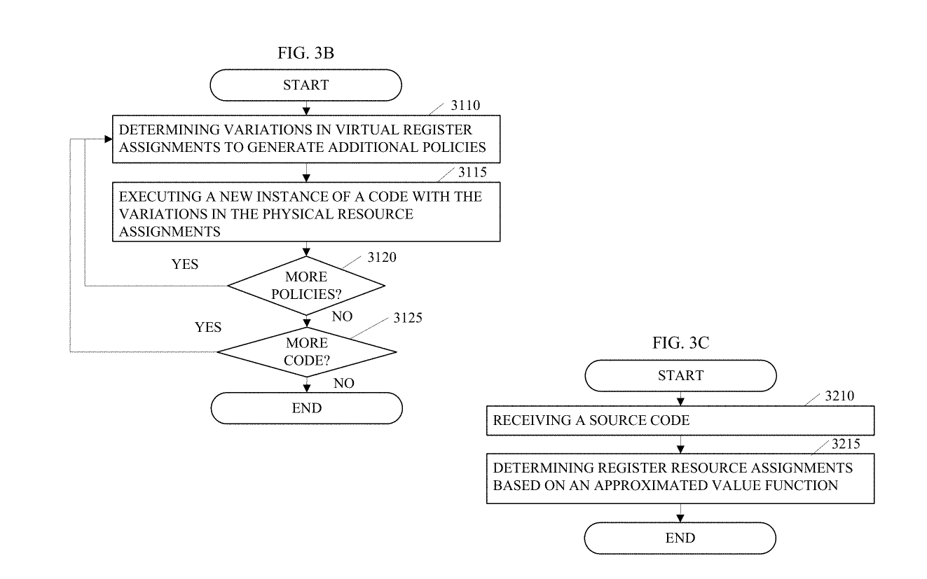

FIGS. 3A-C depict flowcharts of embodiments to generate training data and train a neural network logic, and to determine physical resource assignments with a trained neural network. FIG. 3A illustrates a flowchart to generate training data and to train a neural network. The flowchart starts with identifying an objective (element 3005). In many embodiments, the compiler logic circuitry, such as the compiler logic circuitry 2000 in FIG. 2 and the compiler logic circuitry 1024 in FIG. 1A, may request that the user choose an objective for the compilation process. The objective may seek the fastest execution time or the smallest code size. In further embodiments, the user may select another objective such as a combination of the fastest execution time and smallest code size to seek a balance between these goals. In other embodiments, the compiler logic circuitry may be configured for a specific objective.

After selecting the objective, the compiler logic circuitry may identify one or more states in the source code (element 3010). The one or more states may comprise instructions associated with an action to use virtual resources such as assignment of a variable to a register class or invocation of a task such as computations related to three-dimensional modelling for display on a monitor.

Once the states are identified, the compiler logic circuitry may generate training data for a neural network (element 3015). The compiler circuitry logic may comprise training logic such as the training logic 2020 in FIG. 2 to generate the training data. For instance, the compiler may generate the training data by generating multiple instances of machine code for the source code, wherein each of the instances assign physical resources per a different policy. The policies describe the sequence of actions performed in states found in the source code and the training logic circuitry may create new policies by making adjustments to the default policy of the compilation logic circuitry. The training logic may track the different policies, execute the instances associated with each of the policies, and store the discrete time values for each state and action associated with a policy along with an actual reward associated with the selected objective in the input layer of the neural network logic such as the neural network logic 2040 shown in FIG. 2.

After generating the training data, the compiler logic circuitry may determine an approximated value function (element 3020) by applying weights and biases to the transitivity layer of the neural network logic. The neural network logic may then determine a mini-batch of training samples (element 3025) and pass the mini-batch of samples to a gradient descent logic of the neural network logic.

The neural network logic may determine a gradient descent of the approximated value function based on the mini-batch (element 3030) and perform backpropagation (element 3035) to backpropagate the output of the gradient descent through the transitivity layer of the neural network logic. If there are additional mini-batches available in the epoch to process (element 3040), the flowchart returns to element 3025 to determine the next mini-batch. If there are no more mini-batches in the epoch, the compiler logic circuitry may determine if the approximated value functions of the optimal policies have converged (element 3045). If the functions have not converged then the neural network logic may require additional training and the flowchart returns to element 3010. On the other hand, if the functions have converged, the generation of training data and the training of the neural network logic may be complete.

FIG. 3B illustrates a flowchart for generating training data. The flowchart begins with determining variations in the physical resource assignments to generate additional policies (element 3110). A compiler logic circuitry, such as the compiler logic circuitry 2000 in FIG. 2 and the compiler logic circuitry 1024 in FIG. 1A, may generate different instances of machine code for a source code to provide a variety of different policies for the neural network logic to explore. The neural network requires a large number of policies for training data and, in many embodiments, policies related to different source code to provide the neural network with sufficient information to identify optimal policies. In some embodiments, the compiler logic circuitry methodically changes each action in each state of a source code to determine different policies. Some embodiments selectively vary default physical resource assignments in the states based on a likelihood that such changes may be beneficial by identifying portions of the source code that have a higher concentration of live variables. Some embodiments implement genetic logic functionality and random logic functionality. Further embodiments implement each of the above methods as well as other methods of generating additional policies.

After determining variations in the assignment of physical resources, the compiler logic circuitry may execute the new instance of machine code for a source code with the variations in the physical resource assignments (element 3115) to produce the training data associated with the new policy. Other embodiments may statically determine the training data from the instance of the machine code. If the compiler logic circuitry determines that additional policies should be created from the source code (element 3120) such as to meet a minimum number of policies or because there are additional portions of the code with states that might benefit from changing the action, the flowchart returns to element 3110. If there is additional code to develop training data (element 3125) the flowchart returns to element 3110 to begin anew with the new source code. Otherwise, generation of the training data ends.

FIG. 3C illustrates a flowchart for determining physical resource assignments with a compiler logic circuitry such as the compiler logic circuitry 2000 illustrated in FIG. 2 and the compiler logic circuitry 1024 in FIG. 1A. The flowchart begins with receiving a source code (element 3210). The source code may include two or more states associated with instructions that utilize virtual resources. The compiler logic circuity may perform an intermediate transformation to the code to identify the states in the code associated with an action of assigning a virtual resource and identify the potential actions based on the actions modeled during the training of neural network logic of the compiler logic circuitry. Thereafter, the neural network logic of the compiler logic circuitry may compare metrics of the intermediate version of the source code against the initial states and actions of each of the optimal policies in the neural network logic to select an optimal policy to follow for the source code, which identifies physical resource assignments based on the approximated value function (element 3215). In other embodiments, the compiler logic circuitry may generate a machine code instance of the source code to measure one or more metrics such as total execution time, execution times between states, total code size, number of lines of code between states, the number of spills and fills, and the like. In further embodiments, the neural network logic may train to identify optimal policies for more than one objective and the compiler logic circuitry may require input from the developer to select one of the objectives.

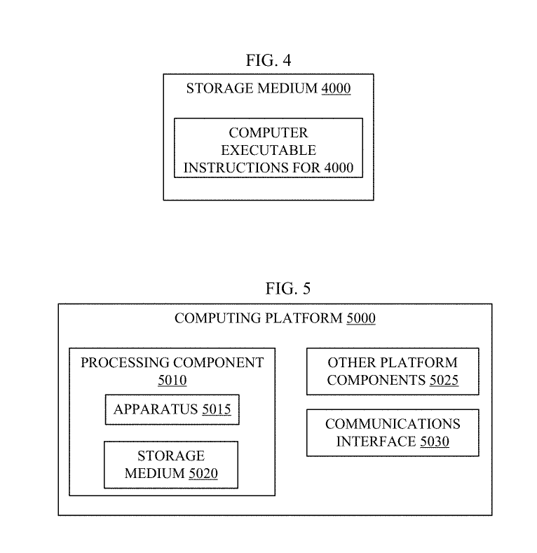

FIG. 4 illustrates an example of a storage medium 4000 to store processor data structures. Storage medium 4000 may comprise an article of manufacture. In some examples, storage medium 4000 may include any non-transitory computer readable medium or machine readable medium, such as an optical, magnetic or semiconductor storage. Storage medium 4000 may store various types of computer executable instructions, such as instructions to implement logic flows and/or techniques described herein. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

FIG. 5 illustrates an example computing platform 5000. In some examples, as shown in FIG. 5, computing platform 5000 may include a processing component 5010, other platform components or a communications interface 5030. According to some examples, computing platform 5000 may be implemented in a computing device such as a server in a system such as a data center or server farm that supports a manager or controller for managing configurable computing resources as mentioned above. Furthermore, the communications interface 5030 may comprise a wake-up radio (WUR) and may be capable of waking up a main radio of the computing platform 5000.

According to some examples, processing component 5010 may execute processing operations or logic for apparatus 5015 described herein. Processing component 5010 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements, which may reside in the storage medium 5020, may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 5025 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 5030 may include logic and/or features to support a communication interface. For these examples, communications interface 5030 may include one or more communication interfaces that operate according to various communication protocols or standards to communicate over direct or network communication links. Direct communications may occur via use of communication protocols or standards described in one or more industry standards (including progenies and variants) such as those associated with the PCI Express specification. Network communications may occur via use of communication protocols or standards such as those described in one or more Ethernet standards promulgated by the Institute of Electrical and Electronics Engineers (IEEE). For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”). Network communication may also occur according to one or more OpenFlow specifications such as the OpenFlow Hardware Abstraction API Specification. Network communications may also occur according to Infiniband Architecture Specification, Volume 1, Release 1.3, published in March 2015 (“the Infiniband Architecture specification”).

Computing platform 5000 may be part of a computing device that may be, for example, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of computing platform 5000 described herein, may be included or omitted in various embodiments of computing platform 5000, as suitably desired.

The components and features of computing platform 5000 may be implemented using any combination of discrete circuitry, ASICs, logic gates and/or single chip architectures. Further, the features of computing platform 5000 may be implemented using microcontrollers, programmable logic arrays and/or microprocessors or any combination of the foregoing where suitably appropriate. It is noted that hardware, firmware and/or software elements may be collectively or individually referred to herein as “logic”.

It should be appreciated that the exemplary computing platform 5000 shown in the block diagram of FIG. 5 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and also implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

Several embodiments have one or more potentially advantages effects. For instance, determining a physical resource assignment via a neural network logic trained to determine an optimal policy for assignment of the physical resources in source code advantageously optimizes compilations and reduces compilation time. Generating training data to train a neural network by generating multiple instances of machine code for one or more source codes in accordance with different policies advantageously provides a basis to train a neural network to identify an optimal policy for source code to optimize compilations and reduce compilation time. Generating different policies by adjusting, combining, mutating, and/or randomly changing a previous policy advantageously provides a basis to train a neural network to identify an optimal policy for source code to optimize compilations and reduce compilation time. Executing and measuring and/or statically determining measurements for each instance of a machine code associated with a source code to determine a reward associated with each state in the source code advantageously provides a basis to train a neural network to identify an optimal policy for source code to optimize compilations and reduce compilation time. Applying weights and biases to the training data to approximate a value function advantageously provides a basis to train a neural network to identify an optimal policy for source code to optimize compilations and reduce compilation time. Determining a mini-batch for gradient descent advantageously reduces computation and increases the chance of convergence. Determining a gradient descent of the approximated value function reduces computation and increases the chance of convergence. Backpropagating of the output from the gradient descent to adjust the weights and biases to determine an optimal policy advantageously trains a neural network to identify an optimal policy for source code to optimize compilations and reduce compilation time.

### Examples of Further Embodiments

The following examples pertain to further embodiments. Specifics in the examples may be used anywhere in one or more embodiments.

Example 1 an apparatus to determine a physical resource assignment. The apparatus comprises a compiler logic circuitry to identify one or more states in a code, the one or more states to comprise virtual resources to assign to physical resources; to generate training data for a neural network logic of the compiler logic circuitry, the training data to comprise more than one policy, each policy comprising the one or more states, each state having a status of the code, an action, and an expected reward for assignment of a virtual resource to a physical resource; the neural network logic to model two or more physical resource assignments as actions; to determine an approximated value function based on the training data; and to determine the physical resource assignment based on the approximated value function. In Example 2, the apparatus of Example 1, wherein the compiler logic circuitry comprises the neural network logic to determine the approximated value function by iterative determination of a gradient descent of the approximated value function and backpropagation of error to incrementally converge to the approximated value function; and to determine the physical resource assignment based on the approximated value function. In Example 3, the apparatus of Example 1, wherein the neural network logic comprises a transitivity layer configured to apply an activation function to the approximated value function with a weight and a bias. In Example 4, the apparatus of Example 3, wherein the neural network logic is configured to train by backpropagation to incrementally update the weight and the bias based on a difference determined between an actual reward and the expected reward for the one or more states in the training data.

In Example 5, the apparatus of Example 1, wherein the neural network logic comprises a mini-batch logic configured to determine a sample set of training data with which to perform a gradient descent. In Example 6, the apparatus of Example 1, wherein the compiler logic circuitry comprises a genetic logic to determine different sequences of physical resource assignments to generate the training data for the code, wherein each of the different sequences is identified as a policy. In Example 7, the apparatus of Example 6, wherein the compiler logic circuitry comprises the genetic logic to determine a new sequence of physical resource assignments for the code by combining sequences from two or more of the different sequences. In Example 8, the apparatus of Example 6, wherein the compiler logic circuitry comprises the genetic logic to select two or more sequences of the different sequences to combine based on evaluation scores for the two or more sequences.

In Example 9, the apparatus of Example 6, wherein the compiler logic circuitry comprises the genetic logic to mutate one sequence of the different sequences to generate another sequence of assignments for the code. In Example 10, the apparatus of Example 6, wherein the compiler logic circuitry comprises a random logic to generate a new sequence of the different sequences by insertion of a random assignment of a physical resource for the code. In Example 11, the apparatus of Example 6, wherein the compiler logic circuitry comprises the training logic to execute multiple instances of the code and multiple instances of other code, each instance of the code having different sequences of physical resource assignments for the code and each instance of the other code having different sequences of physical resource assignments for the other code. In Example 12, the apparatus of Example 1, wherein the physical resource assignment comprises an assignment of a register class or an assignment of a task to a processor. In Example 13, A system to determine a physical resource assignment, the system comprising a memory comprising a dynamic random access memory coupled with a processor of the compiler logic circuitry in accordance with any one of Examples 1-12.

Example 14 is a method to determine a physical resource assignment. The method comprises identifying, by a compiler logic circuitry, one or more states in a code, the one or more states to comprise virtual resources to assign to physical resources; generating, by the compiler logic circuitry, training data for a neural network of the compiler logic circuitry, the training data to comprise more than one policy, each policy comprising the one or more states, each state having a status of the code, an action, and an expected reward for assignment of a virtual resource to a physical resource, the neural network to model two or more physical resource assignments as actions; and training, by the compiler logic circuitry, the neural network logic by determining an approximated value function based on the training data; and determining the physical resource assignment based on the approximated value function. In Example 15, the method of Example 14, further comprising determining, for a different code, an optimal assignment of the virtual resource to the physical resource based on the training data and a current state of the different code. In Example 16, the method of Example 14, wherein generating the training data comprises executing multiple instances of the code compiled with multiple different sequences of assignments of the virtual resources to the physical resources, and measuring objective metrics associated with the approximated value function for each instance. In Example 17, the method of Example 14, wherein generating the training data further comprises executing multiple instances of one or more different codes, wherein each of the one or more different codes is compiled with multiple different sequences of assignments of the virtual resources to the physical resources, and measuring objective metrics associated with the approximated value function for each instance.

In Example 18, the method of Example 14, wherein generating the training data comprises performing a genetic logic function to determine virtual resource assignments to physical resources, the genetic logic function to combine sequences of assignments from two or more different instances of the code, to introduce a mutation into one or more sequences of assignments of virtual resources to physical resources to generate additional sequences of assignments, or to both combine the sequences and to introduce the mutation. In Example 19, the method of Example 14, wherein generating the training data comprises performing a random logic function to determine virtual resource assignments to physical resources, the random logic function to introduce a random change into sequences of assignments of virtual resources to physical resources to generate additional sequences of assignments. In Example 20, the method of Example 14, wherein generating the training data comprises performing a genetic logic to select sequences of assignments from two or more different instances of the code based on evaluation scores for the sequences of assignments produced by the approximated value function. In Example 21, the method of Example 14, wherein training the neural logic comprises training the neural network logic by determining the approximated value function by iterative determination of a gradient descent of the approximated value function and backpropagation of error to incrementally converge to the approximated value function. In Example 22, the method of Example 14, wherein training the neural network logic comprises performing a gradient descent to backpropagate changes to weights and biases associated with the more than one states and more than one policies.

In Example 23, the method of Example 14, wherein the physical resource assignment comprises an assignment of a register class or an assignment of a task to a processor. In Example 24, a computer readable medium having stored thereon instructions that when executed cause a computer to perform operations comprising the operations of any one of Examples 14-23. In Example 25, an apparatus to determine a physical resource assignment, the apparatus comprising a means for performing any one of Examples 14-23. In Example 26, a program for causing a computer to perform operations comprising operations of any one of Examples 14-23. In Example 27, a computer-readable storage medium for storing the program of Example 26.

Example 28 is a system to determine a physical resource assignment. The system comprises a memory comprising a dynamic random access memory; a compiler logic circuitry coupled with the memory to identify one or more states in a code, the one or more states to comprise virtual resources to assign to physical resource; to generate training data for a neural network logic of the compiler logic circuitry, the training data to comprise more than one policy, each policy comprising the one or more states, each state having a status of the code, an action, and an expected reward for assignment of a virtual resource to a physical resource; the neural network logic to model two or more physical resource assignments as actions; to determine an approximated value function based on the training data; and to determine the physical resource assignment based on the approximated value function. In Example 29, the system of Example 28, wherein the compiler logic circuitry comprises the neural network logic to determine the approximated value function by iterative determination of a gradient descent of the approximated value function and backpropagation of error to incrementally converge to the approximated value function; and to determine the physical resource assignment based on the approximated value function. In Example 30, the system of Example 28, wherein the neural network logic comprises a transitivity layer configured to apply an activation function to the approximated value function with a weight and a bias. In Example 31, the system of Example 30, wherein the neural network logic is configured to train by backpropagation to incrementally update the weight and the bias based on a difference determined between an actual reward and the expected reward for the one or more states in the training data.

In Example 32, the system of Example 28, wherein the neural network logic comprises a mini-batch logic configured to determine a sample set of training data with which to perform a gradient descent. In Example 33, the system of Example 28, wherein the compiler logic circuitry comprises a genetic logic to determine different sequences of assignments of virtual resources to physical resources to generate the training data for the code. In Example 34, the system of Example 33, wherein the compiler logic circuitry comprises the genetic logic to determine a new sequence of assignments of virtual resources to physical resources for the code by combining sequences from two or more of the different sequences. In Example 35, the system of Example 33, wherein the compiler logic circuitry comprises the genetic logic to select two or more sequences of the different sequences to combine based on evaluation scores for the two or more sequences. In Example 36, the system of Example 33, wherein the compiler logic circuitry comprises the genetic logic to mutate one sequences of the different sequences to generate another sequence of assignments of virtual resources to physical resources for the code.

In Example 37, the system of Example 33, wherein the compiler logic circuitry comprises a random logic to generate a new sequence of the different sequences by insertion of a random assignment of the virtual resource to the physical resource for the code. In Example 38, the system of Example 33, wherein the compiler logic circuitry comprises the training logic to execute multiple instances of the code and multiple instances of other code, each instance of the code having different sequences of assignments of virtual resources to physical resources for the code and each instance of the other code having different sequences of assignments of virtual resources to physical resources for the other code. In Example 39, the system of Example 33, wherein the physical resource assignment comprises an assignment of a register class or an assignment of a task to a processor.

Example 40 is a non-transitory machine-readable medium containing instructions, which when executed by a processor, cause the processor to perform operations. The operations comprises identifying, by a compiler logic circuitry, one or more states in a code, the one or more states to comprise virtual resources to assign to physical resources; generating, by the compiler logic circuitry, training data for a neural network of the compiler logic circuitry, the training data to comprise more than one policy, each policy comprising the one or more states, each state having a status of the code, an action, and an expected reward for assignment of a virtual resource to a physical resource, the neural network to model two or more physical resource assignments as actions; and training, by the compiler logic circuitry, the neural network logic by determining an approximated value function based on the training data; and determining a physical resource assignment based on the approximated value function. In Example 41, the machine-readable medium of Example 40, wherein the operations further comprise determining, for a different code, an optimal assignment of the virtual resource to the physical resource based on the training data and a current state of the different code. In Example 42, the machine-readable medium of Example 40, wherein generating the training data comprises executing multiple instances of the code compiled with multiple different sequences of assignments of the virtual resources to the physical resources, and measuring objective metrics associated with the approximated value function for each instance.

In Example 43, the machine-readable medium of Example 40, generating the training data further comprises executing multiple instances of one or more different codes, wherein each of the one or more different codes is compiled with multiple different sequences of assignments of the virtual resources to the physical resources, and measuring objective metrics associated with the approximated value function for each instance. In Example 44, the machine-readable medium of Example 40, wherein generating the training data comprises performing a genetic logic function to determine virtual resource assignments to physical resources, the genetic logic function to combine sequences of assignments from two or more different instances of the code, to introduce a mutation into one or more sequences of assignments of virtual resources to physical resources to generate additional sequences of assignments, or to both combine the sequences and to introduce the mutation. In Example 45, the machine-readable medium of Example 40, wherein generating the training data comprises performing a random logic function to determine virtual resource assignments to physical resources, the random logic to introduce a random change into sequences of assignments of virtual resources to physical resources to generate additional sequences of assignments. In Example 46, the machine-readable medium of Example 40, wherein generating the training data comprises performing a genetic logic function to select sequences of assignments from two or more different instances of the code based on evaluation scores for the sequences of assignments produced by the approximated value function. In Example 47, the machine-readable medium of Example 40, wherein training the neural logic comprises training the neural network logic by determining the approximated value function by iterative determination of a gradient descent of the approximated value function and backpropagation of error to incrementally converge to the approximated value function. In Example 48, the machine-readable medium of Example 40, wherein training the neural network logic comprises performing a gradient descent to backpropagate changes to weights and biases associated with the more than one states and more than one policies. In Example 49, the machine-readable medium of Example 40, the physical resource assignment comprises an assignment of a register class or an assignment of a task to a processor.

Example 50 is an apparatus to determine a physical resource assignment. The apparatus comprises a means for identifying one or more states in a code, the one or more states to comprise virtual resources to assign to physical resources; a means for generating training data for a neural network of a compiler logic circuitry, the training data to comprise more than one policy, each policy comprising the one or more states, each state having a status of the code, an action, and an expected reward for assignment of a virtual resource to a physical resource, the neural network to model two or more physical resource assignments as actions; and a means for training the neural network logic by determining an approximated value function based on the training data; and a means for determining the physical resource assignment based on the approximated value function. In Example 51, the apparatus of Example 50, further comprising a means for determining, for a different code, an optimal assignment of the virtual resource to the physical resource based on the training data and a current state of the different code. In Example 52, the apparatus of Example 50, wherein the means for generating the training data comprises a means for executing multiple instances of the code compiled with multiple different sequences of assignments of the virtual resources to the physical resources, and a means for measuring objective metrics associated with the approximated value function for each instance. In Example 53, the apparatus of Example 50, wherein the means for generating the training data further comprises a means for executing multiple instances of one or more different codes, wherein each of the one or more different codes is compiled with multiple different sequences of assignments of the virtual resources to the physical resources, and a means for measuring objective metrics associated with the approximated value function for each instance.

In Example 54, the apparatus of Example 50, wherein the means for generating the training data comprises a means for performing a genetic logic function to determine virtual resource assignments to physical resources, the genetic logic function to combine sequences of assignments from two or more different instances of the code, to introduce a mutation into one or more sequences of assignments of virtual resources to physical resources to generate additional sequences of assignments, or to both combine the sequences and to introduce the mutation. In Example 55, the apparatus of Example 50, wherein the means for generating the training data comprises a means for performing a random logic to determine virtual resource assignments to physical resources, the random logic to introduce a random change into sequences of assignments of virtual resources to physical resources to generate additional sequences of assignments. In Example 56, the apparatus of Example 50, wherein the means for generating the training data comprises a means for performing a genetic logic to select sequences of assignments from two or more different instances of the code based on evaluation scores for the sequences of assignments produce by the approximated value function.

In Example 57, the apparatus of Example 50, wherein the means for training the neural logic comprises a means for training the neural network logic by determining the approximated value function by iterative determination of a gradient descent of the approximated value function and backpropagation of error to incrementally converge to the approximated value function. In Example 58, the apparatus of Example 50, wherein the means for training the neural network logic comprises a means for performing a gradient descent to backpropagate changes to weights and biases associated with the more than one states. In Example 59, the apparatus of Example 50, the physical resource assignment comprises an assignment of a register class or an assignment of a task to a processor.

What is claimed is:

1. An apparatus to determine a physical resource assignment, the system comprising:
a compiler logic circuitry to identify one or more states in a code, the one or more states to comprise virtual resources to assign to physical resources; to generate training data for a neural network logic of the compiler logic circuitry, the training data to comprise more than one policy, each policy comprising the one or more states, each state having a status of the code, an action, and an expected reward for assignment of a virtual resource to a physical resource;
the neural network logic to model two or more physical resource assignments as actions; to determine an approximated value function based on the training data; and to determine the physical resource assignment based on the approximated value function.

2. The apparatus of claim 1, wherein the compiler logic circuitry comprises the neural network logic to determine the approximated value function by iterative determination of a gradient descent of the approximated value function and backpropagation of error to incrementally converge to the approximated value function; and to determine the physical resource assignment based on the approximated value function.

3. The apparatus of claim 1, wherein the neural network logic comprises a transitivity layer configured to apply an activation function to the approximated value function with a weight and a bias.

4. The apparatus of claim 1, wherein the neural network logic comprises a mini-batch logic configured to determine a sample set of training data with which to perform a gradient descent.

5. The apparatus of claim 1, wherein the compiler logic circuitry comprises a genetic logic to determine different sequences of physical resource assignments to generate the training data for the code, wherein each of the different sequences is identified as a policy.

6. The apparatus of claim 5, wherein the compiler logic circuitry comprises a random logic to generate a new sequence of the different sequences by insertion of a random assignment of a physical resource for the code.

7. The apparatus of claim 1, wherein the physical resource assignment comprises an assignment of a register class or an assignment of a task to a processor.

8. A method to determine a physical resource assignment, the method comprising:
identifying, by a compiler logic circuitry, one or more states in a code, the one or more states to comprise virtual resources to assign to physical resources;
generating, by the compiler logic circuitry, training data for a neural network of the compiler logic circuitry, the training data to comprise more than one policy, each policy comprising the one or more states, each state having a status of the code, an action, and an expected reward for assignment of a virtual resource to a physical resource, the neural network to model two or more physical resource assignments as actions; and
training, by the compiler logic circuitry, the neural network logic by determining an approximated value function based on the training data; and
determining the physical resource assignment based on the approximated value function.

9. The method of claim 8, wherein generating the training data further comprises executing multiple instances of one or more different codes, wherein each of the one or more different codes is compiled with multiple different sequences of assignments of the virtual resources to the physical resources, and measuring objective metrics associated with the approximated value function for each instance.

10. The method of claim 8, wherein generating the training data comprises performing a genetic logic function to determine virtual resource assignments to physical resources, the genetic logic function to combine sequences of assignments from two or more different instances of the code, to introduce a mutation into one or more sequences of assignments of virtual resources to physical resources to generate additional sequences of assignments, or to both combine the sequences and to introduce the mutation.

11. The method of claim 8, wherein generating the training data comprises performing a genetic logic to select sequences of assignments from two or more different instances of the code based on evaluation scores for the sequences of assignments produced by the approximated value function.

12. The method of claim 8, wherein training the neural logic comprises training the neural network logic by determining the approximated value function by iterative determination of a gradient descent of the approximated value function and backpropagation of error to incrementally converge to the approximated value function.

13. The method of claim 8, wherein the physical resource assignment comprises an assignment of a register class or an assignment of a task to a processor.

14. A system to determine a physical resource assignment, the system comprising:
a memory comprising a dynamic random access memory;
a compiler logic circuitry coupled with the memory to identify one or more states in a code, the one or more states to comprise virtual resources to assign to physical resource; to generate training data for a neural network logic of the compiler logic circuitry, the training data to comprise more than one policy, each policy comprising the one or more states, each state having a status of the code, an action, and an expected reward for assignment of a virtual resource to a physical resource;
the neural network logic to model two or more physical resource assignments as actions;
to determine an approximated value function based on the training data; and to determine the physical resource assignment based on the approximated value function.

15. The system of claim 14, wherein the compiler logic circuitry comprises the neural network logic to determine the approximated value function by iterative determination of a gradient descent of the approximated value function and backpropagation of error to incrementally converge to the approximated value function; and to determine the physical resource assignment based on the approximated value function.

16. The system of claim 15, wherein the neural network logic is configured to train by backpropagation to incrementally update the weight and the bias based on a difference determined between an actual reward and the expected reward for the one or more states in the training data.

17. The system of claim 14, wherein the compiler logic circuitry comprises a random logic to generate a new sequence of the different sequences by insertion of a random assignment of the virtual resource to the physical resource for the code.

18. The system of claim 17, wherein the compiler logic circuitry comprises the training logic to execute multiple instances of the code and multiple instances of other code, each instance of the code having different sequences of assignments of virtual resources to physical resources for the code and each instance of the other code having different sequences of assignments of virtual resources to physical resources for the other code.

19. The system of claim 17, wherein the physical resource assignment comprises an assignment of a register class or an assignment of a task to a processor.

20. A non-transitory machine-readable medium containing instructions, which when executed by a processor, cause the processor to perform operations, the operations comprising:
identifying, by a compiler logic circuitry, one or more states in a code, the one or more states to comprise virtual resources to assign to physical resources;
generating, by the compiler logic circuitry, training data for a neural network of the compiler logic circuitry, the training data to comprise more than one policy, each policy comprising the one or more states, each state having a status of the code, an action, and an expected reward for assignment of a virtual resource to a physical resource, the neural network to model two or more physical resource assignments as actions; and
training, by the compiler logic circuitry, the neural network logic by determining an approximated value function based on the training data; and
determining a physical resource assignment based on the approximated value function.

21. The machine-readable medium of claim 20, wherein the operations further comprise determining, for a different code, an optimal assignment of the virtual resource to the physical resource based on the training data and a current state of the different code.

22. The machine-readable medium of claim 20, wherein generating the training data comprises performing a genetic logic function to determine virtual resource assignments to physical resources, the genetic logic function to combine sequences of assignments from two or more different instances of the code, to introduce a mutation into one or more sequences of assignments of virtual resources to physical resources to generate additional sequences of assignments, or to both combine the sequences and to introduce the mutation.

23. The machine-readable medium of claim 20, wherein generating the training data comprises performing a genetic logic function to select sequences of assignments from two or more different instances of the code based on evaluation scores for the sequences of assignments produced by the approximated value function.

24. The machine-readable medium of claim 20, wherein training the neural logic comprises training the neural network logic by determining the approximated value function by iterative determination of a gradient descent of the approximated value function and backpropagation of error to incrementally converge to the approximated value function.

25. The machine-readable medium of claim 20, the physical resource assignment comprises an assignment of a register class or an assignment of a task to a processor.
